(19) United States
(12) Patent Application Publication
(10) Pub. No.: US 2014/0149027 A1
(43) Pub. Date: May 29, 2014

(54) TRAFFIC ALERTING SYSTEM

(71) Applicant: David T. RYAN, Concord, CA (US)

(72) Inventor: David T. RYAN, Concord, CA (US)

(21) Appl. No.: 14/080,254

(22) Filed: Nov. 14, 2013

Related U.S. Application Data
(60) Provisional application No. 61/730,006, filed on Nov. 26, 2012.

(51) Int. Cl. G08G 1/00

(52) U.S. Cl. CPC G08G 1/00
USPC 701/117

(57) ABSTRACT

Systems and method including receiving at a server, commute information, said commute information including at least a start location and a destination location and a drive time. Requesting current transit time for the commute information from a remote server, said remote server operable to provide substantially real-time commute information. Receiving at said server the current transit time and comparing the current transit time the drive time, and sending a notification in response to said comparing. Some embodiments may include determining if the current transit time is at or below the drive time and sending messages by email, text message or a web-site posting.

### PRIORITY

This application claims the benefit of co-pending provisional patent application No. 61/730,006 entitled “Traffic Altering System” filed on or near Nov. 26, 2012.

### BACKGROUND

Traffic alerting systems currently provide alerts for when road congestion gets significant enough that a driver would want to plan another route or plan to drive at another time. These systems highlight traffic jams, major accidents and road construction that would likely interfere with a person's commute. However, these systems are limited in that they only when not to travel or when it is advisable to take another route to a destination. The emphasis on these tools is to minimize the travel time. In practice many people travel at (or close to) a specific time each day. If they receive a traffic notification, they may re-route or delay their trip. However, many people simply want to know how bad their commute home is going to be and if they should work a littler later until the traffic clears. This may entail continuously monitoring traffic reports or web sites containing traffic information until the amount of traffic decreases to an acceptable level.

### SUMMARY

Disclosed herein is a system and method for notifying users when traffic rush-hour conditions have subsided to an acceptable level. Generally during rush hour, traffic increases dramatically such that a person's commute time takes significantly longer than during non rush hour periods. Many professionals, instead of sitting in rush hour traffic, choose to work until the rush hour is over to begin their commute to or from work. This disclosure provides for way to repeatably measure traffic commute times during rush hour and until the rush hour traffic subsides and the commute time drops down to an acceptable level (the “breakup” time). Once the acceptable level is met, an electronic notification is sent to a user instructing them the increased traffic level has subsided and they can make their commute drive.

In some embodiments the method includes collecting user information and contact information including their commute beginning and ending address and the time they would normally like to drive. When the time they would go like to drive approaches, methods disclosed herein may employ use commercially available traffic monitoring services to measure the current real time or near real-time information about the commute length. When a commute travel time reaches an acceptable value a notification is sent to the user telling them that rush hour traffic has subsided and they can make their commute.

The benefit of the enclosed disclosure is that people working in their office into the evening will be notified when it's time for them to go without having to continuously check traffic on their own or just guessing when enough time has passed before they commute home.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system 100 that may be employed for some embodiments according to the current disclosure.

FIG. 2A and FIG. 2B illustrate methods which may be employed in certain embodiments according to the current disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### DETAILED DESCRIPTION

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touch screens, displays and terminals as well as remote connected computer systems, modems, radio transmitters and handheld personal communication devices such as cellular phones, “smart phones” and digital assistants.

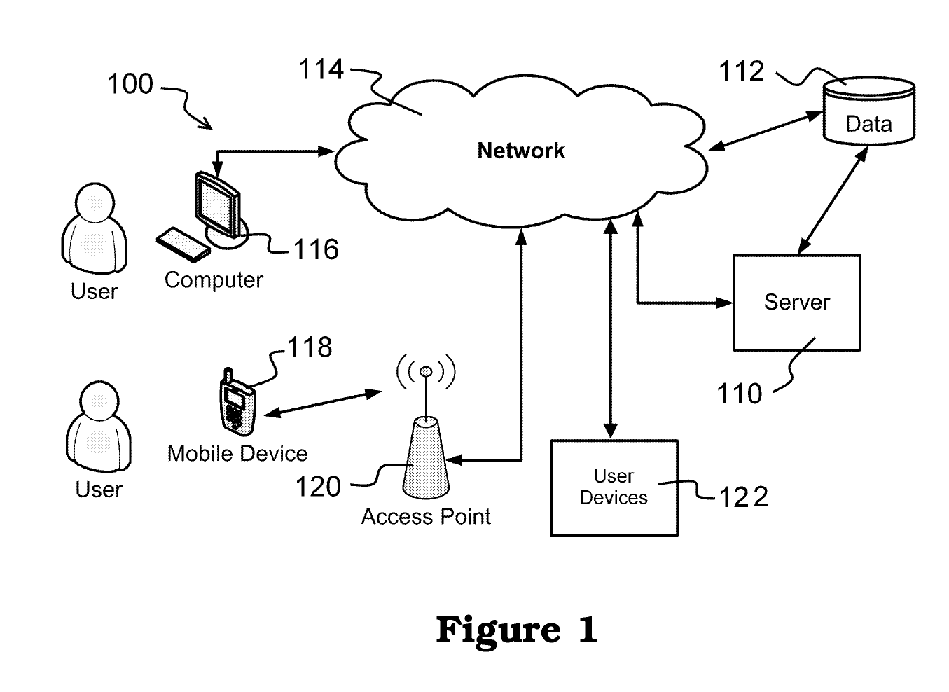

FIG. 1 shows a functional block diagram of a client server system 100 that may be employed for some embodiments according to the current disclosure. In the FIG. 1 a server 110 is coupled to one or more databases 112 and to a public network 114 such as the Internet. The network may include routers, hubs and other equipment to effectuate communications between all associated devices. A user accesses the server by a computer 116 communicably coupled to the network 114. The computer 116 may include a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

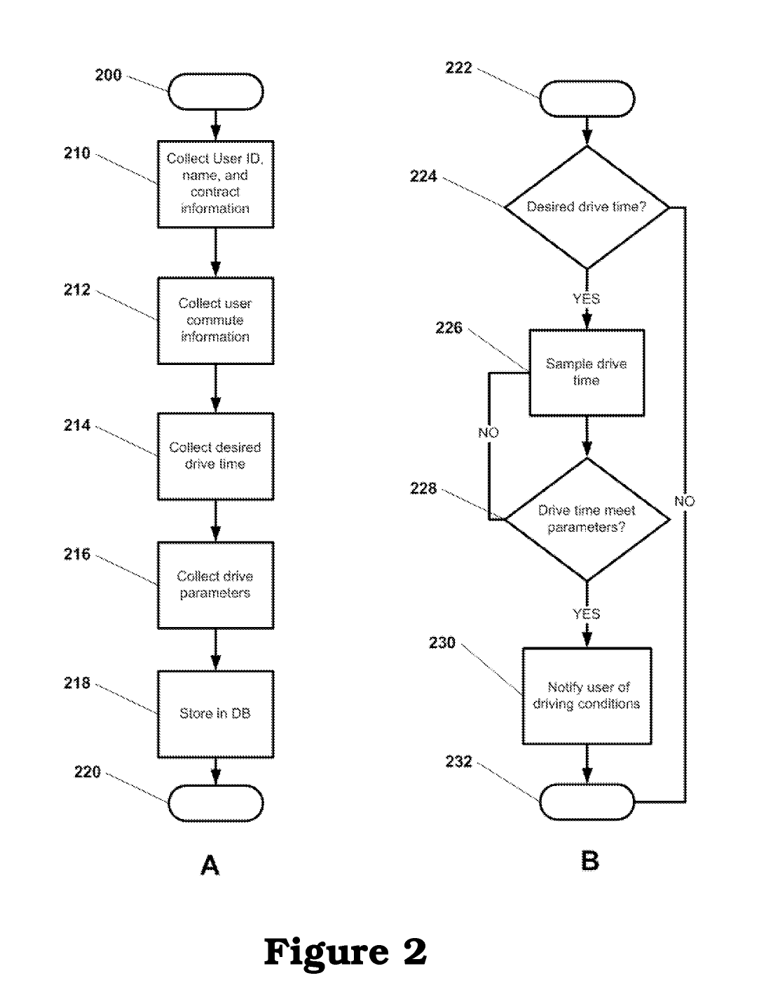

FIG. 2A and FIG. 2B illustrate methods which may be employed in certain embodiments according to the current disclosure. In FIG. 2 a method begins at a flow label 200.

At a step 210 user information is collected. Such user information may include the name and contact information including e-mail telephone and cellular telephone numbers.

At a step 212 commute information is collected from the user. This commute information includes a starting point and an endpoint. Typically the commute information would be a home address and a work address although there is nothing in this disclosure that should limit the commute information to home and work addresses.

At a step 214 the desired drive time is collected from the user. This may be the time the user wants to commute. For example and without limitation, a user may desire to leave work for its home at 5:00 PM.

At a step 216 drive parameters are collected from the user. These drive parameters are predefined and include what would be an acceptable drive time for the commute. For example and without limitation if a user normally takes 20 minutes to make their commutes when there is no traffic, would they be willing to make the drive if it took 30 minutes or 40 minutes? If a user is willing to drive 10 minutes longer but not 20 minutes longer then that information would be one of the parameters collected from the user. In certain embodiments, the user would indicate “normal drive time plus 10 minutes.”

After the step 216 certain quality control measures may be effectuated. These may include verifying the user contact information by sending a text message or by sending an e-mail and having them respond after receiving the message. Other steps may be to verify the commute information is valid. For example and without limitation, the commute information may be fed to an online traffic server to verify the correct addresses and to calculate a commute time. Online traffic servers are commercially available through such online vendors as Google maps and traffic.com among others. Once the commute information and contact information is verified the method moves to a step 218.

At a step 218 the user information is stored in a structured data source such as a database or XML file.

At a flow label 220 the method ends.

At a flow label 222 an other method begins.

At a step 224 a system would query the database to fetch the drive parameters and drive times associated with one or more users. If the current time is the time associated with the user's desired drive time the system advances to a step 226. Otherwise the method ends or reiterates upon itself (not shown) until a desired drive time and the actual time is reached.

At a step 226 a drive time is sampled. The drive time may be sampled by taking the user's commute information including the start and end destination points and applying that information to a traffic server such as that provided by Google maps, traffic.com or other sources. Available traffic information sources provide real-time information of commute times based on the addresses is provided.

At a step 228 the current real time (or near real time) driving parameters are compared to the drive parameters set by the user. For example and without limitation if a user says they would like to be notified when the drive time is less than 10 minutes longer than non-commute time, then the condition for notification would be met.

On certain days traffic could be very light and the drive time is within the acceptable parameters set by the user at the desired commute time. On other days there may be a significant wait for rush hour traffic to subside. In either event the method of FIG. 2B may apply.

If the drive time parameters fall outside of the drives parameter set by the user at the step 216, the method reiterates by going back and testing the drive time again. A delay time may be used between sampling the drive times. For example and without limitation a 5 minute delay may be used before sampling the drive time again at the step 226.

In some embodiments steps 226 and 228 may be repeated to eliminate false positive readings by making sure that the conditions remain with the drive parameters specified in the step 216.

When the drive time reaches the criteria set by the user, the method advances to a step 230.

At the step 230 a notification is sent to a driver. This notification may be an e-mail message or a text message or telephone call other communication protocol as set by the user in the contact information collected in the step 210. In some embodiments, a custom voice message may be sent. Once notification is sent the method moves to a flow label 232.

At a flow label 232 of the method ends.

In some embodiments daily statistics may be transmitted to a user. These statistics include, but are not limited to, the average “break up” time, average breakup times for days of the week, and histories of breakups for holidays, sporting events and the like.

One having skill in the art will appreciate that drive time approximations may be used in lieu of actual drive times. For example and without limitation, if the actual drive time is not readily available, then estimated travel times, based in whole or in part, of measured drive times from nearby roads or freeways, may be used to estimate the actual drive time.

Moreover, in the event of a major delay, certain embodiments may postpone periodic drive time sampling for a period of time and then resume the process until the drive time reaches an acceptable level. In addition, a message may be sent indicating an anticipated opening of traffic after a major delay.

In some embodiments a user can set the notification time in response to a deviation from the average commute time. For example and without limitation, if the average 6 PM commute time for a given route is 32 minutes, the user can request a notification when the current commute time drops below three standard deviations of the average time. Notifications may also be set when the rate of change of the commute time increases at a certain rate. For example and without limitation, when the commute time begins to increase or decrease rapidly.

Some embodiments may employ alternative routes so that if a user has more than one possible way to transverse a commute, notification can be sent when one or more alternative routes breakup.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method including:
receiving at a server, transportation information, said transportation information including at least a start location and a destination;
receiving at said server a transmit time information associated with said transportation information, said receiving from a network coupled to said server;
comparing transit time information to a predetermined time value, and
sending a notification in response to said comparing.

2. The method of claim 1 wherein said comparing includes:
receiving and storing a desired drive time, and
calculating the difference between the transmit time information and the desired drive time.

3. The method of claim 1 wherein said sending includes at least one of an email, a text message or a web posting.

4. The method of claim 1 further including:
requesting additional transmit time information in response to said comparing.

5. A method including:
receiving at a server, commute information, said commute information including at least a start location and a destination location and a drive time;
requesting current transit time for the commute information from a remote server operable to provide substantially real-time commute information;
receiving at said server the current transit time;
comparing the current transit time the drive time, and
sending a notification in response to said comparing.

6. The method of claim 5 wherein said comparing includes determining if the current transit time is at or below the drive time.

7. The method of claim 5 wherein said notification is at least one of either an email, a text message or a web-site posting.

8. The method of claim 5 further including:
sending one or more additional requests for current transit time in response to said comparing.

9. One or more processor readable storage devices having non-transitory processor readable code embodied on said processor readable storage devices, said processor readable code for programming one or more processors to perform a method including:
receiving at a server, transportation information, said transportation information including at least a start location and a destination;
receiving at said server a transmit time information associated with said transportation information, said receiving from a network coupled to said server;
comparing transit time information to a predetermined time value, and
sending a notification in response to said comparing.

10. The device of claim 9 wherein said comparing includes:
receiving and storing a desired drive time, and
calculating the difference between the transmit time information and the desired drive time.

11. The device of claim 9 wherein said sending includes at least one of an email, a text message or a web posting.

12. The device of claim 9 wherein the method further includes:
requesting additional transmit time information in response to said comparing.
